(19) United States
(12) Patent Application Publication
(10) Pub. No.: US 2015/0149950 A1
(43) Pub. Date: May 28, 2015

(54) COMPUTING DEVICE WITH TOUCH-SENSITIVE HOUSING FOR DETECTING PLACEHOLDER INPUT IN CONNECTION WITH A PAGE TURNING ACTION

(71) Applicant: Kobo Inc., Toronto (CA)

(72) Inventors: Robin Bennett, Beeton (CA); Damian Lewis, Toronto (CA); James Wu, Newmarket (CA)

(73) Assignee: Kobo Inc., Toronto (CA)

(21) Appl. No.: 14/088,211

(22) Filed: Nov. 22, 2013

(51) Int. Cl. G06F 3/0483

(52) U.S. Cl. CPC G06F 3/0483
USPC 715/776

(57) ABSTRACT

A computing device includes a housing, a display assembly having a screen, and a touch sensor provided with a portion of the housing. The processor operates to display at least a portion an initial page state for an e-book. The processor interprets one or more user actions of a first type as a page turn, and then responds to the first type of user action by transitioning from displaying at least the initial page state to displaying another page state as determined by a value of the page turn. The processor also interprets user action of a second type as a placeholder. In response to interpreting the user action of the second type as the placeholder, the processor determines a given page state that coincides with the placeholder, and automatically return to displaying the given page state upon completion of an event or condition.

### TECHNICAL FIELD

Examples described herein relate to a computing device with a touch-sensitive housing for detecting a placeholder input in connection with a page turning action.

### BACKGROUND

An electronic personal display is a mobile electronic device that displays information to a user. While an electronic personal display is generally capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

An electronic reader, also known as an e-reader device, is an electronic personal display that is used for reading electronic books (eBooks), electronic magazines, and other digital content. For example, digital content of an e-book is displayed as alphanumeric characters and/or graphic images on a display of an e-reader such that a user may read the digital content much in the same way as reading the analog content of a printed page in a paper-based book. An e-reader device provides a convenient format to store, transport, and view a large collection of digital content that would otherwise potentially take up a large volume of space in traditional paper format.

In some instances, e-reader devices are purpose-built devices designed to perform especially well at displaying readable content. For example, a purpose built e-reader device includes a display that reduces glare, performs well in highly lit conditions, and/or mimics the look of text on actual paper. While such purpose built e-reader devices excel at displaying content for a user to read, they can also perform other functions, such as displaying images, emitting audio, recording audio, and web surfing, among others.

There also exist numerous kinds of consumer devices that can receive services and resources from a network service. Such devices can operate applications or provide other functionality that links the device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing application resources on a computing device, according to an embodiment.

FIG. 2 illustrates an example of an e-reader device or other electronic personal display device, for use with one or more embodiments described herein.

FIG. 3 is a frontal view of e-reader device in accordance with one or more embodiments.

FIG. 4 illustrates an e-reader system for displaying paginated content, according to one or more embodiments.

FIG. 5 illustrates a method for displaying paginated content, according to one or more embodiments.

FIG. 6 illustrates an example of an e-book device that is operated by the user to provide a placeholder input while performing page a page turning action, according to one or more embodiments.

### DETAILED DESCRIPTION

Embodiments described herein provide for a computing device that interprets a specific kind of user action as input corresponding to a placeholder for a given page state, in context of displaying paginated content such as an e-book. In some embodiments, a user action corresponding to a gesture or contact with a touch-sensitive interface of a computing device is interpreted as a placeholder.

Still further, in some embodiments, an electronic display device such as an e-reader device is provided with a housing that includes touch-sensitive regions or surfaces that are separate from a display surface. In such embodiments, a user interaction with the touch-sensitive regions or surfaces of the housing can be interpreted as a placeholder in the context of a page turning action.

According to some embodiments, a computing device includes a housing, a display assembly having a screen, and a touch sensor provided with a portion of the housing. The processor operates to display at least a portion of an initial page state for an e-book. The processor interprets one or more user actions of a first type as a page turn, and then responds to the first type of user action by transitioning from displaying at least the initial page state to displaying another page state as determined by a value of the page turn. The processor also interprets user action of a second type as a placeholder. In response to interpreting the user action of the second type as the placeholder, the processor determines a given page state that coincides with the placeholder, and automatically returns to displaying the given page state upon completion of an event or condition.

Among other benefits, examples described herein enable a personal display device such as an e-reader device to be equipped with sensors that enable a user to transition through pages of an e-book in a manner that mimics how users flip through the pages of a paperback.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

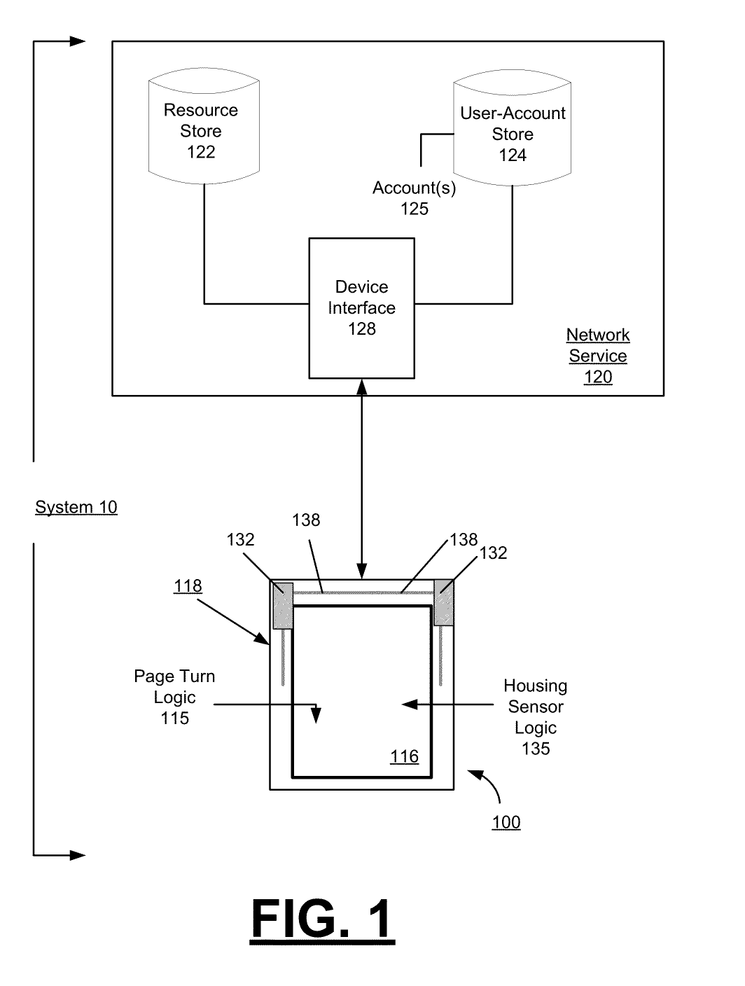

FIG. 1 illustrates a system for providing e-book services, according to an embodiment. In an example of FIG. 1, system 10 includes an electronic display device, shown by way of example as an e-reader device 100, and a network service 120. The network service 120 can include multiple servers and other computing resources that provide various services in connection with one or more applications that are installed on the e-reader device 100. By way of example, in one implementation, the network service 120 can provide e-book services which communicate with the e-reader device 100. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reader device 100 can correspond to any electronic personal display device on which applications and application resources (e.g., e-books, media files, documents) can be rendered and consumed. For example, the e-reader device 100 can correspond to a tablet or a telephony/messaging device (e.g., smart phone). In one implementation, for example, e-reader device 100 can run an e-reader application that links the device to the network service 120 and enables e-books provided through the service to be viewed and consumed. In another implementation, the e-reader device 100 can run a media playback or streaming application that receives files or streaming data from the network service 120. By way of example, the e-reader device 100 can be equipped with hardware and software to optimize certain application activities, such as reading electronic content (e.g., e-books). For example, the e-reader device 100 can have a tablet-like form factor, although variations are possible. In some cases, the e-reader device 100 can also have an E-ink display.

In additional detail, the network service 120 can include a device interface 128, a resource store 122 and a user account store 124. The user account store 124 can associate the e-reader device 100 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reader device 100 may be associated with the user account 125, and multiple devices may be associated with the same account. As described in greater detail below, the e-reader device 100 can store resources (e.g., e-books) that are purchased or otherwise made available to the user of the e-reader device 100, as well as to archive e-books and other digital content items that have been purchased for the user account 125, but are not stored on the particular computing device.

With reference to an example of FIG. 1, e-reader device 100 can include a display screen 116 and a housing 118. In an embodiment, the display screen 116 is touch-sensitive, to process touch inputs including gestures (e.g., swipes). Additionally, the housing 118 can be integrated with touch sensors 138 to provide touch sensing regions 132. In example of FIG. 1, the touch sensing regions 132 are provided on the bezel of the housing 118, such as on a periphery of the display screen 116 and/or on a back surface (not shown) of the housing 118.

In some embodiments, the e-reader device 100 includes features for providing and enhancing functionality related to displaying paginated content. The e-reader device can include page turning logic 115, which enables the user to transition through paginated content. The e-reader device can display pages from e-books, and enable the user to transition from one page state to another. In particular, an e-book can provide content that is rendered sequentially in pages, and the e-book can display page states in the form of single pages, multiple pages or portions thereof. Accordingly, a given page state can coincide with, for example, a single page, or two or more pages displayed at once. The page turning logic 115 can operate to enable the user to transition from a given page state to another page state. In some implementations, the page turning logic 115 enables single page transitions, chapter transitions, or cluster transitions (multiple pages at one time).

The page turning logic 115 can be responsive to various kinds of interfaces and actions in order to enable page turning. In one implementation, the user can signal a page turn event to transition page states by, for example, interacting with the displays screen 116. For example, the user can touch or swipe a left or right region of the display screen to indicate a sequential direction of a page turn. In variations, the user can specify different kinds of page turning input (e.g., single page turns, multiple page turns, chapter turns) through different kinds of input. Additionally, the page turn input of the user can be provided with a magnitude to indicate a magnitude (e.g., number of pages) in the transition of the page state. For example, a user can touch and hold a region of the display screen in order to cause a cluster or chapter page state transition, while a tap in the same region can effect a single page state transition (e.g., from one page to a next in sequence). By way of example, the user can provide a first type of input (e.g., single tap on edge of display screen 116) through the display screen 116 to signify a single page turn, a second type of input (e.g., tap and hold on edge portion of display screen 116) to signify a mufti-page transition, and/or a third type of input to specify a chapter transition (e.g., tap and downward motion on display screen 116). As another example, the user can specify page turns of different kinds or magnitudes through single taps, sequenced taps or patterned taps entered onto the display screen 116 or at sensing regions 132.

According to some embodiments, the e-reader device 100 includes housing sensor logic 135 to detect and interpret user input made through interaction with the housing touch sensors 138. By way of example, the housing sensor logic 135 can detect taps, multiple taps or gestures made through user interaction with the housing sensing regions 132 (which can coincide with discrete regions or entire surface of device). The housing sensor logic 135 can interpret such input received through the sensing regions 132 in a variety of ways. For example, in the context of an e-book application, the user can enter input through the sensing region 132 to, for example, mark a page or passage. In more general context, input through the housing sensing regions 132 can be interpreted in order to, for example, turn the device on, or open a current e-book.

According to some embodiments, the user can provide input by touching or otherwise interacting with the e-reader device in order to enhance the page turning functionality. In one embodiment, the user can provide a touch or gesture input through interaction with the sensing regions 132 of the e-reader device in order to provide a placeholder for concurrent or subsequent page turning input. When input corresponding to a placeholder is detected, a given page state is determined to coincide with the placeholder input. Additional page turning resulting from the user interacting with, for example, the displays screen 116 can be performed or processed to transition page states on the e-book. After the page turning is complete, the e-reader device returns the page state to the particular page state that coincided with the placeholder.

Hardware Description

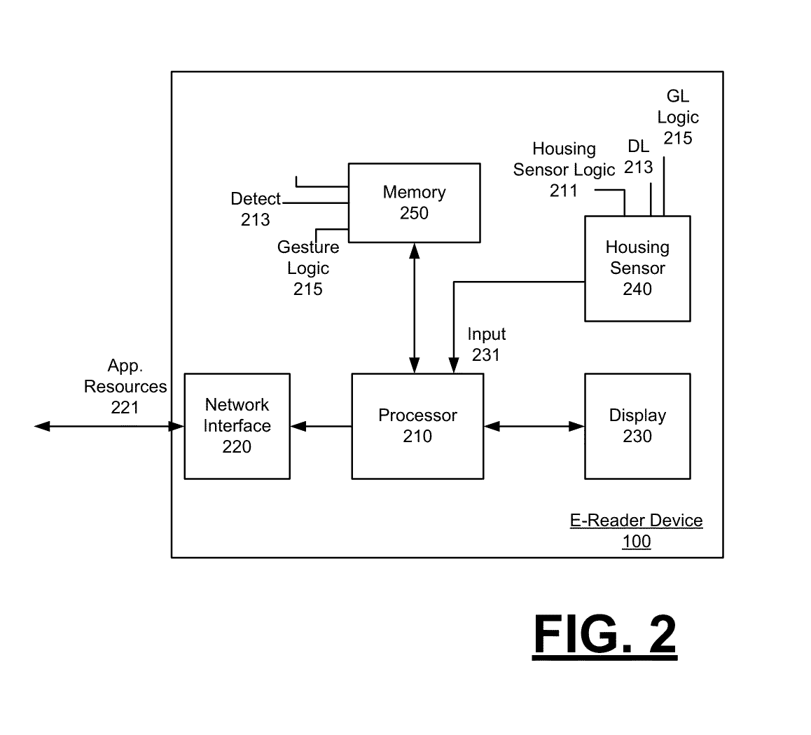

FIG. 2 illustrates an example of an e-reader device or other electronic personal display device, for use with one or more embodiments described herein. In an example of FIG. 2, an e-reader device 100 can correspond to, for example, a device, such as also shown by an example of FIG. 1. With reference to FIG. 2, e-reader device 100 includes a processor 210, a network interface 220, a display 230, one or more housing sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reader device 100 can access the network service 120 to receive various kinds of resources (e.g., digital content items such as e-books, configuration files, account information), as well as to provide information (e.g., user account information, service requests etc.). For example, e-reader device 100 can receive application resources 221, such as e-books or media files, that the user elects to purchase or otherwise download from the network service 120. The application resources 221 that are downloaded onto the e-reader device 100 can be stored in the memory 250.

In some implementations, the display 230 can correspond to, for example, a liquid crystal display (LCD) or light emitting diode (LED) display that illuminates in order to provide content generated from processor 210. In some implementations, the display 230 can be touch-sensitive. In some variations, the display 230 can correspond to an electronic paper type display, which mimics conventional paper in the manner in which content is displayed. Examples of such display technologies include electrophoretic displays, electrowetting displays, and electrofluidic displays.

The processor 210 can receive input from various sources, including the housing sensor components 240, the display 230 or other input mechanisms (e.g., buttons, keyboard, microphone, etc.). With reference to examples described herein, the processor 210 can respond to input 231 from the housing sensor components 240. In one embodiment, the processor 210 responds to input 231 from the housing sensor component 240 in order to facilitate or enhance e-book activities such as page turning. By way of example, the input 231 can signify a placeholder for a page state when the user is performing a page turning action on an e-book.

In some embodiments, the e-reader device 100 includes housing sensor logic 211 that monitors for touch input provided through the housing sensor component 240, and further processes the input as a particular input or type of input. In one implementation, the housing sensor logic 211 can be integrated with the housing sensor. For example, the housing sensor component 240 can be provided as a modular component that includes integrated circuits or other hardware logic, and such resources can provide some or all of the housing sensor logic (see also housing sensor logic 135 of FIG. 1). For example, integrated circuits of the housing sensor component 240 can monitor for touch input and/or process the touch input as being of a particular kind. In variations, some or all of the housing sensor logic 211 is implemented with the processor 210 (which utilizes instructions stored in the memory 250), or with an alternative processing resource.

In one implementation, the housing sensor logic 211 includes detection logic 213 and gesture detect logic 215. The detection logic 213 implements operations to monitor for the user contacting a surface of the housing coinciding with placement of the sensor. The gesture detect logic 215 detects and correlates a particular gesture (e.g., user pinching corner, swiping, tapping etc.) as a particular type of input or user action. The gesture detect logic 215 can also detect directionality so as to distinguish between, for example, leftward or rightward swipes.

E-Book Housing Configurations

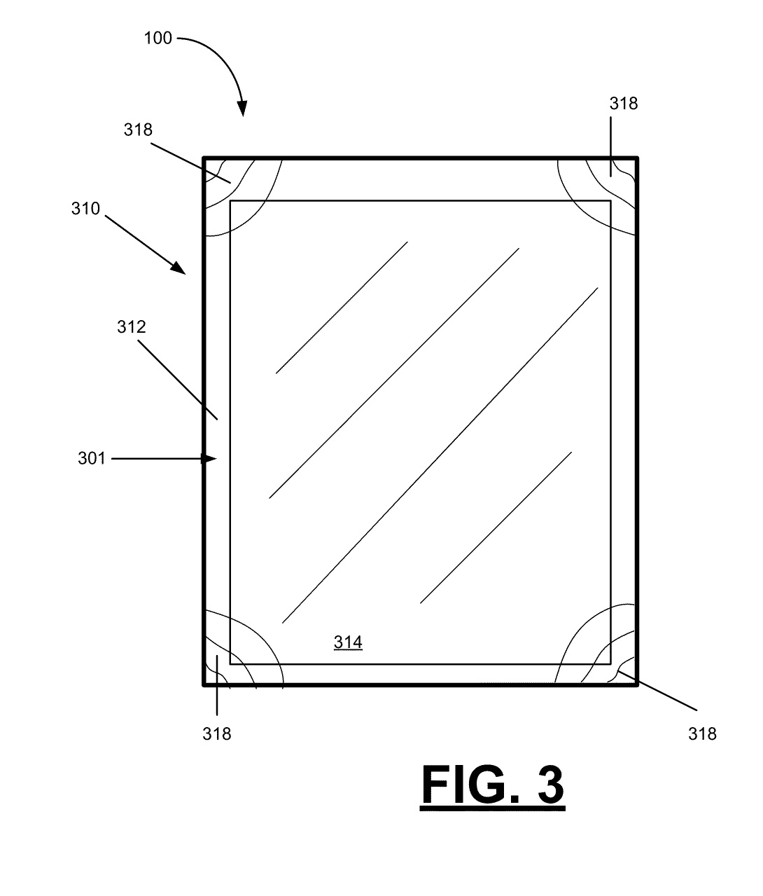

FIG. 3 is a frontal view of e-reader device 100, according to an embodiment. The e-reader device 100 includes a housing 310 having a front bezel 312 and a display screen 314. The e-reader device 100 can be substantially tabular or rectangular, so as to have a front surface 301 that is substantially occupied by the display screen 314 so as to enhance content viewing. The display screen 314 can be part of a display assembly, and can be touch sensitive. For example, the display screen 314 can be provided as a component of a modular display assembly that is touch-sensitive and integrated with housing 310 during a manufacturing and assembly process.

According to examples described herein, the e-reader device 100 includes one or more discrete housing sensing regions 318 distributed at various locations of the housing 310. Each housing sensing region 318 can coincide with the integration of touch-sensors with the housing 310. While an example of FIG. 3 provides for discrete sensing regions 318, variations can provide for a portion or even all of the surface area of the housing 310 to be integrated with touch-sensors in order to enable touch-sensitivity form the device at any location of, for example, the front surface 301 and/or back surface (not shown). Furthermore, while an example of FIG. 3 illustrates sensing regions 318 at each corner of the e-reader device 100, variations can provide for more or fewer sensing regions 318. For example, sensing regions 318 can be provided at only top corners of the device, or along the entire front bezel 312 (or substantial portion thereof) of the front surface 301.

According to embodiments, the e-reader device 100 can integrate one or more types of touch-sensitive technologies in order to provide touch-sensitivity on both housing sensing regions 318 and on the display screen 314. It should be appreciated that a variety of well-known touch sensing technologies may be utilized to provide touch-sensitivity at either the sensing regions 318 or on the display screen 314. By way of example, touch-sensors used with each of the sensing regions 318 or display screen 314 can utilize resistive touch sensors; capacitive touch sensors (using self and/or mutual capacitance); inductive touch sensors; or infrared touch sensors. For example, sensing regions 318 can be employed using resistive sensors, which can respond to pressure applied to the front surface 301 in areas coinciding with the sensing regions 318. In a variation, the sensing regions 318 can be implemented using a grid pattern of electrical elements which detect capacitance inherent in human skin. Alternatively, sensing regions 318 can be implemented using a grid pattern of electrical elements which are placed on or just beneath the front surface 301, and which deform sufficiently on contact to detect touch from an object such as a finger. More generally, touch-sensing technologies for implementing the sensing region 318 (or display screen 314) can employ resistive touch sensors, capacitive touch sensors (using self and/or mutual capacitance), inductive touch sensors, or infrared touch sensors.

Additionally, the sensing regions 318 (as well as the display screen 314) can be equipped to detect multiple simultaneous touches. For example, with reference to an example of FIG. 3, a processor of the e-reader device 100 can process input from the sensing regions 318 in order to be responsive (or distinctly detect) simultaneous user touch on both the front surface 301 and back surface (not shown). For example, the user can pinch a corner of the e-reader device 100 as a form of input. In such an example, the pinch can be interpreted as a specific type of input (e.g., pinch input) or as a general input (e.g., housing touched).

Page Transition Functionality

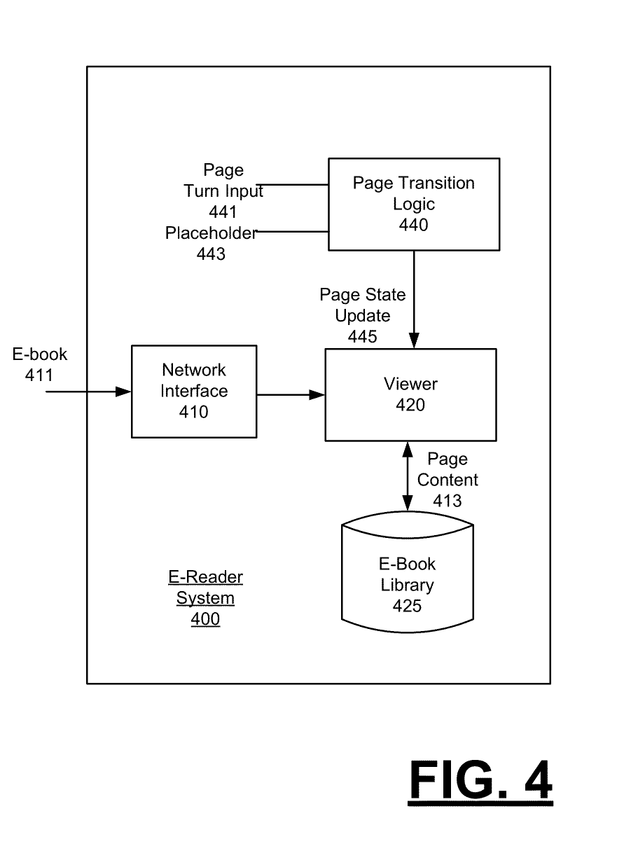

FIG. 4 illustrates an e-reader system for displaying page content, according to one or more embodiments. An e-reader system 400 can be implemented as for example, an application or device, using components that execute on, for example, an e-reader device such as shown with examples of FIG. 1, FIG. 2 or FIG. 3. Furthermore, an e-reader system 400 such as described can be implemented in a context such as shown by FIG. 1, and configured as described by an example of FIG. 2 and FIG. 3.

In an example of FIG. 4, a system 400 includes a network interface 410, a viewer 420 and page transition logic 440. As described with an example of FIG. 1, the network interface 410 can correspond to a programmatic component that communicates with a network service in order to receive data and programmatic resources. For example, the network interface 410 can receive an e-book 411 from the network service that the user purchases and/or downloads. E-books 411 can be stored as part of an e-book library 425 with memory resources of an e-reader device (e.g., see memory 250 of e-reader device 100).

The viewer 420 can access page content 413 from a selected e-book, provided with the e-book library 425. The page content 413 can correspond to one or more pages that comprise the selected e-book. The viewer 420 renders one or more pages on a display screen at a given instance, corresponding to the retrieved page content 413. The page state can correspond to a particular page, or set of pages that are displayed at a given moment.

The page transition logic 440 can be provided as a feature or functionality of the viewer 420. Alternatively, the page transition logic 440 can be provided as a plug-in or as independent functionality from the viewer 420. The page transition logic 440 can signal page state updates 445 to the viewer 420. The page state update 445 can specify a page transition, causing the viewer 420 to render a new page. In specifying the page state update 445, the page transition logic 440 can provide for single page turns, multiple page turns or chapter turns. The page state update 445 for a single page turn causes the viewer 420 to transition page state by presenting page content 413 that is next in sequence (forward or backward) to the page content that is being displayed. The page state update 445 for a multi-page turn causes the viewer 420 to transition page state by presenting page content 413 that is a jump forward or backward in sequence from the page state under display. Likewise, the page state update 445 for a chapter turn causes the viewer 420 to transition page state by presenting page content 413 that is a next chapter in sequence (forward or backward) to a chapter of a current page state. Accordingly, the page state update 445 can signify a transition value representing the page state that is to be displayed next (e.g., one page transition or ten page transition) or a transition type (e.g., page versus chapter transition).

According to some embodiments, the page transition logic 440 can be responsive to different kinds of input, including an input action which signifies page turns (or page transitions) 441 and an input action which signifies a placeholder. The page turn input 441 can include, for example, single page turns, mufti-page turns or chapter turns. The type of page turn input 441 can be determined from the type of input provided. For example, the page turn input 441 can be provided by the user interacting with the display surface of the device, and single taps on the touch-sensitive display screen can be interpreted as single page turns. Likewise, other input such as touch and hold can be interpreted as a mufti-page turn or chapter input. Still further, actions such as a tap and swipe can be interpreted as a chapter transition.

In response to receiving a page turn input 441, the page transition logic 440 signals the page state update 445 to the viewer 420. The viewer 420 updates the page content 413 to reflect the change represented by the page state update 445 (e.g., single page transition, multi-page transition, or chapter transition).

According to some embodiments, the placeholder input 443 can be received by the user interacting with, for example, the sensing regions of the housing. The placeholder input 443 can alternatively be provided by the user performing a designated kind of action (e.g., specific gesture). The page transition logic 440 can respond to the placeholder input 443 by recording a return-to page state that coincides with the placeholder 443. The return-to page state can correspond to the page state that is present just prior to the placeholder 443 being detected. Subsequently, page turn input 441 can be received and/or processed. Once the page transition input 441 is complete (e.g., page transition designated by the page turn input 441 are performed), the placeholder input 443 causes the page transition logic 440 to signal a page state update 445 to the viewer 420 that corresponds to the return-to page state. The viewer 420 then updates the page content 413 on display for the return-to page state.

Methodology

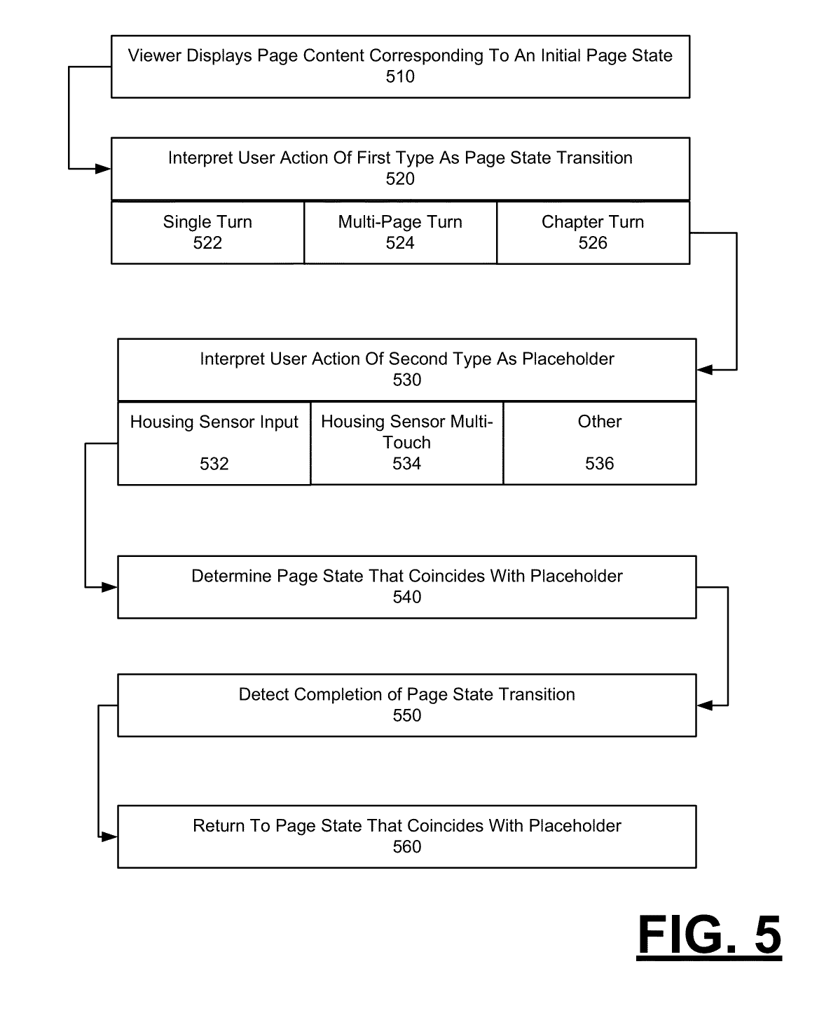

FIG. 5 illustrates a method for displaying page content, according to one or more embodiments. In describing an example of FIG. 5, reference may be made to components such as described with FIG. 4 for purpose of illustrating suitable components for performing a step or sub-step being described.

With reference to an example of FIG. 5, the viewer 420 displays page content corresponding to an initial page state (510). For example, the viewer 420 can display a single page corresponding to the page being read by the user, or alternatively, display multiple pages side-by-side to reflect a display mode preference of the user.

User action of a first type can be interpreted in order to enable a page state transition (520). The user action of the first type can correspond to one or more of a single page turn (522), a multi-page turn (524), or a chapter turn (526). For example, page transition logic 440 can receive page turn input 441, and signal a corresponding page state update 445 to the viewer 420. The user action of the first type can correspond to, for example, (i) a user swiping a touch-screen or other sensor region of a computing device to reflect a sequence direction (forward or backward), magnitude (single or mufti-page) or type (page versus chapter turns); (ii) a user touching (e.g., tap or tap and hold) a touch-screen or other sensor region of the computing device to reflect direction, magnitude or type; and/or (iii) button actuation.

User action of a second type can be interpreted in order to record a placeholder input (530). In one implementation, the placeholder input 443 can be received before or at the same time as the page transition input 441. For example, the user can perform the user action of the second type in order to record the placeholder (as provided in 530), then initiate page turning (as provided in 520). In this way, the placeholder input 443 can be in effect for a given page transition or series of page transitions.

In examples described herein, the user action corresponding to the placeholder input 443 can be detected using a different interface than that used to detect the page transition input 441. In some embodiments, the placeholder input 443 is detected through a housing sensor of the device, while the page transition input 441 is detected through another interface (touch-screen of display device, buttons, etc.). Thus, for example, the placeholder input 443 can be detected through a housing sensor action such as a single tap (532), a mufti-touch input detected through the housing sensor (534), or some other input (536) (e.g., combination of housing sensor and display, button etc.).

In response to detecting the placeholder input 443, the page state coinciding with the placeholder input is identified and recorded (540). The page state can reflect one or more pages that are being displayed when the placeholder input is detected. For example, page transition logic 440 can receive placeholder input 443, and record a current page state as coinciding with the placeholder.

The page state transition that is triggered by the page transition input 441 is detected as being complete (550). In one implementation, the page transition logic 440 can detect when the page transition input 441 is complete. In one variation, the page state transition can be detected as being complete when the user ceases performing the action for providing the placeholder input 443. For example, the user can hold a finger or set of fingers on the housing sensor in order to enter the placeholder input 443 (e.g., interact with housing sensor) while entering the page transition input 441. When the user ceases the placeholder input 443 (e.g., lifts hand from the housing sensor), the page state transition may be deemed to be complete. Alternatively, the placeholder input 443 can be provided as a discrete event (e.g., the user enters input through the housing sensor), and the page transition input 441 can be entered at the same time or after the placeholder input 443. The completion of the page transition input 441 can coincide with, for example, a condition or event designating the completion of the page state transition, such as completion of a duration of time.

In response to detecting completion of the page state transition, a return-to the page state coinciding with the placeholder input 443 is performed (560). For example, the page transition logic 440 can signal the viewer 420 a page state update 445 that identifies the return-to page or page state, and the viewer 420 can display page content corresponding to the return-to page.

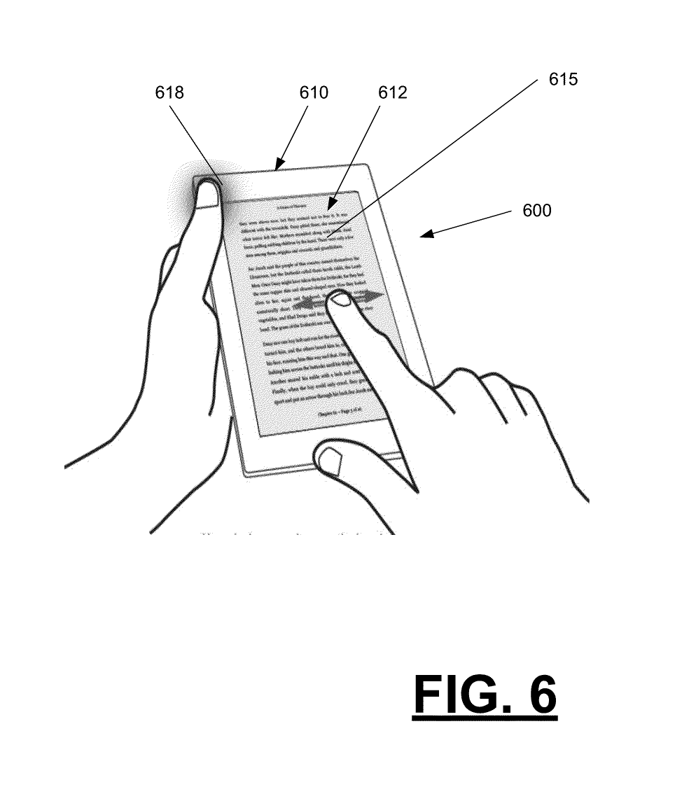

FIG. 6 illustrates an example of an e-book device that is operated by the user to input a placeholder while performing page turns, according to one or more embodiments. An example of FIG. 6 can be implemented using an e-book device such as described with examples of FIG. 1 through FIG. 5. An e-reader device 600 can include a housing 610 and a display 612. In an example provided, each of the housing 610 and display 612 are touch-sensitive. Thus, for example, the e-book device can include a housing configuration such as shown with an example of FIG. 3.

At a particular moment, the display 612 can be used to render a particular page 615 of an e-book. In an example of FIG. 6, the user can perform an action corresponding to a lateral swipe across a portion of the display screen 612 in order to provide input corresponding to a page turn (e.g., single page turn, multi-page turn, chapter turn). The user can also perform an action corresponding to a pinch (user required to contact both sides of the housing 610) or tap (user touches corner 618 on just one side) in order to enter input corresponding to a placeholder. In variations, the tap or pinch can be performed in alternative regions of the housing 610.

In an example of FIG. 6, the user can first pinch the corner of the device to enter the placeholder input, then perform a swipe to enter the page transition input. The user can enter multiple page transition input (e.g., multiple swipes) while pinching or otherwise providing the placeholder input 641. Still further, in some variations, the user can enter a chapter page transition using a combination of inputs (e.g., tap and drag). Once the user lifts the finger from the housing 610 so as to cease the placeholder input, the device returns to the page that is recorded as coinciding with the placeholder input.

An example of FIG. 6 illustrates an embodiment which enables a user to interact with e-reader device 600 to facilitate activities such as page or chapter flipping. Moreover, the action required from the user to record a placeholder input and a resulting return-to page is intuitive, and facilitates the user in mimicking the act of flipping through pages of a paper back with one hand while holding a current page as a placeholder with the fingers of the other hand.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a housing;
a display assembly including a screen;
a touch sensor provided with a portion of the housing;
wherein the housing at least partially circumvents the screen so that the screen is viewable;
a processor provided within the housing, the processor operating to:
display at least a portion of an initial page state for an e-book;
interpret one or more user actions of a first type as a page turn, and respond to the first type of user action by transitioning from displaying at least the initial page state to displaying another page state as determined by a value or type of the page turn;
interpret user action of a second type, detected through the touch sensor, as a placeholder; and
in response to interpreting the user action of the second type as the placeholder, determine a given page state that coincides with the placeholder, and automatically return to displaying the given page state upon completion of an event or condition.

2. The computing device of claim 1, wherein the one or more processors detect the user action of the second type before detecting the user action of the first type, so that the given page state coinciding with the placeholder input corresponds to the initial page state.

3. The computing device of claim 2, wherein the one or more processors return to the initial page state from the other page state identified from completion of the page turn.

4. The computing device of claim 1, wherein the one or more processors detect the user action of the second type at substantially the same time as the user action of the first type.

5. The computing device of claim 1, wherein the one or more processors detect the user action of the second type after detecting the user action of the first type, so that the given page state coinciding with the placeholder input does not correspond to the initial page state.

6. The computing device of claim 1, wherein in response to interpreting the user action of the second type as the placeholder, the processor determines the given page state by determining that the given page state is being displayed when the placeholder is detected.

7. The computing device of claim 1, wherein the touch sensor is provided with a bezel that circumvents at least a portion of the screen of the display assembly.

8. The computing device of claim 1, wherein the processor interprets (i) a user contact with the screen of the display assembly as the user action of the first type, and (ii) a user contact with the housing, separate from the screen of the display assembly, as the user action of the second type.

9. The computing device of claim 1, wherein the user action of the second type corresponds to a pre-determined gesture performed on a portion of the housing.

10. The computing device of claim 9, wherein the user action of the second type corresponds to a pinch action performed at a location detectable to the touch sensor of the housing.

11. The computing device of claim 9, wherein the user action of the first type corresponds to a user touching the screen of the display assembly.

12. The computing device of claim 9, wherein the processor interprets the user action of the first type as being a mufti-page transition in the displayed page state of the e-book.

13. The computing device of claim 1, wherein the processor automatically returns to displaying the given page state upon completion of the event or condition corresponding to a user ceasing to perform the action of the second type.

14. The computing device of claim 1, wherein the processor automatically returns to displaying the given page state upon completion of a duration of time after the placeholder is interpreted from the user action of the second type.

15. A method for operating a computing device, the method being implemented by one or more processors and comprising:
displaying at least a portion of an initial page state for an e-book;
interpreting one or more user actions of a first type as a page turn;
responding to the first type of user action by transitioning from displaying at least the initial page state to displaying another page state as determined by a value of the page turn;
interpreting user action of a second type, detected through a user contact with a housing of the computing device, as a placeholder; and
in response to interpreting the user action of the second type as the placeholder, determining a given page state that coincides with the placeholder; and
automatically returning to displaying the given page state upon completion of an event or condition.

16. The method of claim 15, wherein interpreting the user action of the first type includes detecting a user contacting a display screen of the computing device, and wherein interpreting the user action of the second type includes detecting a user contacting a portion of the housing, apart from the display screen.

17. The method of claim 15, wherein detecting the user action of the second type is performed before or at substantially the same time as detecting the user action of the first type, so that the given page state coinciding with the placeholder input corresponds to the initial page state.

18. The method of claim 17, wherein the one or more processors return to the initial page state from the other page state identified from completion of the page turn.

19. The method of claim 15, wherein the user action of the second type corresponds to a pre-determined gesture performed on a portion of the housing.

20. A non-transitory computer-readable medium that stores instructions, that when executed by one or more processors, cause the one or more processors to perform operations that include:
displaying at least a portion of an initial page state for an e-book on a computing device;
interpreting one or more user actions of a first type as a page turn;
responding to the first type of user action by transitioning from displaying at least the initial page state to displaying another page state as determined by a value of the page turn;
interpreting user action of a second type, detected through a user contact with a housing of the computing device, as a placeholder; and
in response to interpreting the user action of the second type as the placeholder, determining a given page state that coincides with the placeholder; and
automatically returning to displaying the given page state upon completion of an event or condition.
